(19) United States
(12) Patent Application Publication
(10) Pub. No.: US 2023/0217925 A1
(43) Pub. Date: Jul. 13, 2023

(54) FENCLORIM SEED TREATMENT AS A BIOSTIMULANT

(71) Applicant: THE BOARD TRUSTEES OF THE UNIVERSITY OF ARKANSAS, Little Rock, AR (US)

(72) Inventor: Jason K. Norsworthy, West Fork, AR (US)

(21) Appl. No.: 18/095,418

(22) Filed: Jan. 10, 2023

Related U.S. Application Data
(60) Provisional application No. 63/297,993, filed on Jan. 10, 2022.

(51) Int. Cl. A01N 43/54

(52) U.S. Cl. CPC A01N 43/54

(57) ABSTRACT

The present invention provides methods in which early season vigor or canopy formation are stimulated in cereal plants via application of a fenclorim seed treatment. Methods for planting fenclorim-treated seeds at a lower than recommended seed count are also provided.

### CROSS-REFERENCE TO RELATED APPLICATIONS

This application claims priority to U.S. Provisional Application No. 63/297,993 filed on Jan. 10, 2022, the contents of which are incorporated by reference in their entireties.

### BACKGROUND OF THE INVENTION

Rice is an ancient agricultural crop that remains one of the principal food crops of the world. There are two cultivated species of rice: Oryza sativa L., the Asian rice, and O. glaberrima Steud., the African rice. O. sativa L. constitutes virtually all of the world's cultivated rice and is the species grown in the United States. Given the importance of cereal grains as food crops, methods for improved cultivation of such grains are needed.

### BRIEF SUMMARY OF THE INVENTION

In a first aspect, the present invention provides agricultural methods that comprise stimulating early season vigor or canopy formation in a cereal plant by treating seed of the cereal plant with an effective amount of fenclorim and planting it.

In a second aspect, the present invention provides methods for comparing the early season vigor or canopy formation of a cereal plant grown from a seed that was treated with an effective amount of fenclorim to that of a control plant. The methods comprise (a) growing the cereal plant and the control plant under substantially similar conditions; (b) measuring an indicator of early season vigor or canopy formation in both the cereal plant and the control plant; and (c) comparing the measurements obtained in (b).

In a third aspect, the present invention provides agricultural methods that comprise planting cereal seed treated with an effective amount of fenclorim at a lower than recommended seed count.

### BRIEF DESCRIPTION OF THE DRAWINGS

FIG. 1 is a bar graph comparing the leaf area of rice plants grown from fenclorim-treated seed to that of rice plants grown from seed that was not treated with fenclorim.

FIG. 2 is a bar graph comparing the groundcover of rice plants grown from fenclorim-treated seed to that of rice plants grown from seed that was not treated with fenclorim. Groundcover is presented as “relative groundcover,” a percentage of the groundcover produced by the rice plants grown from seed that was not treated with fenclorim.

FIG. 3 is a bar graph comparing the aboveground biomass of rice plants grown from fenclorim-treated seed to that of rice plants grown from seed that was not treated with fenclorim.

FIG. 4 is a bar graph comparing the belowground biomass of rice plants grown from fenclorim-treated seed to that of rice plants grown from seed that was not treated with fenclorim.

FIG. 5 is a bar graph comparing the total biomass of rice plants grown from fenclorim-treated seed to that of rice plants grown from seed that was not treated with fenclorim.

### DETAILED DESCRIPTION OF THE INVENTION

Disclosed herein is the use of fenclorim (4,6-dichloro-2-phenylpyrimidine) as a biostimulant. A “biostimulant” is a substance that stimulates natural processes that enhance nutrient uptake, nutrient use efficiency, tolerance to abiotic stress, crop quality, or any combination thereof. In the Examples, the inventors demonstrate that applying fenclorim to the seeds of rice plants stimulates early season vigor and canopy formation. Specifically, rice plants grown from fenclorim-treated seeds were shown to exhibit increased groundcover, increased shoot numbers, increased leaf area, and increased biomass as compared to control plants grown from seeds that were not treated with fenclorim. These effects may result in improved weed control, increased tillering, and/or reduced yield loss in adverse conditions and allow for the use of a reduced seeding rate as compared to conventional recommendations.

### Methods of Stimulating Early Season Vigor or Canopy Formation in Cereal Plants:

In a first aspect, the present invention provides agricultural methods that comprise stimulating early season vigor or canopy formation in a cereal plant by treating seed of the cereal plant with an effective amount of fenclorim and planting it.

The term “early season vigor” refers to the ability of a plant to grow and thrive during the early season. The term “early season” refers to a period of less than 60 days after emergence (i.e., less than 60 days after a growing plant has emerged from the soil). In some contexts, early season refers to a period of less than 30, 35, 40, 45, 50, or 55 days after emergence. Suitably, early season may refer to a period from about 1-60, 10-55, 20-50, or 30-45 days after emergence. The term “canopy formation” refers to the formation of the aboveground portion of a plant and is measured as a percentage of the ground area covered by the plant. Early season vigor or canopy formation can be assessed based on various parameters including, without limitation, leaf area, plant density, plant height, dry matter accumulation, and various growth parameters.

In Example 2, the inventors demonstrate that, at 30 days after emergence, rice plants grown from fenclorim-treated seeds have increased groundcover, increased leaf area, increased aboveground biomass, increased belowground biomass, and increased total biomass as compared to control plants. Thus, in some embodiments, the methods of the present invention increase the leaf area, groundcover, aboveground biomass, belowground biomass, total biomass, or any combination thereof of the cereal plant relative to a control plant. In some embodiments, the methods increase the leaf area, groundcover, aboveground biomass, belowground biomass, or total biomass of the cereal plant by a statistically significant amount relative to the control plant within the early season.

As used herein, a “control plant” is a comparable plant (e.g., of the same species, variety, and age) that was grown under substantially similar conditions but was grown from a seed that was not treated with fenclorim. Plants that are grown in “substantially similar conditions” are grown in similar locations and soil conditions, are planted with similar timing, are subjected to similar abiotic stresses, and the like.

When grown under substantially similar conditions, plants of the same variety are expected to exhibit statistically insignificant differences in the absence of a difference in treatment. The term “statistically significant” refers to an experimentally verifiable result that is not likely to occur randomly but is instead likely to be attributable to specific cause (e.g., the fenclorim seed treatment). In some embodiments, a statistically significant result is one in which the p-value is less than 0.05. In certain embodiments, a statistically significant result is one in which the p-value is less than 0.02, 0.01, 0.005, 0.002, or 0.001.

As used herein, the term “leaf area” refers to the sum of the surface area of all living aboveground foliage of a plant per unit of ground area. In some embodiments, the methods result in a statistically significant increase in leaf area within the early season. In some embodiments, the methods result in a statistically significant increase in leaf area within 45 or 30 days after emergence. In some embodiments, leaf area is increased by at least 5%, 10%, 15%, 20%, or more than 20%.

As used herein, the term “groundcover” refers to the area occupied by the aboveground foliage of a plant when viewed from above. Groundcover may be determined, for example, based on the number of green leaf pixels in an overhead image. In some embodiments, the methods result in a statistically significant increase in groundcover within the early season. In some embodiments, the methods result in a statistically significant increase in ground cover within 45 or 30 days after emergence. In some embodiments, the methods result in a statistically significant increase in groundcover in heavy clay soil. In some embodiments, groundcover is increased by at least 4%, 5%, 10%, 15%, or more than 15%.

The term “biomass” is used herein to refer to the mass of a portion of plant material (i.e., both live and dead). Biomass may be calculated as dry weight or fresh weight. “Fresh weight” is determined by simply harvesting plant material and weighing it, whereas “dry weight” is determined by harvesting plant material, drying it in an oven, and then weighing it. For example, the plant material may be dried in an oven at 140-160° F. (60-70° C.) for 24-48 hours.

As used herein, the terms “aboveground biomass” and “shoot biomass” refer to the biomass of the aboveground portion of a plant. In some embodiments, the methods result in a statistically significant increase in aboveground biomass within the early season. In some embodiments, the methods result in a statistically significant increase in aboveground biomass within 45 or 30 days after emergence. In some embodiments, aboveground biomass is increased by at least 5%, 10%, or more than 10%.

As used herein, the terms “belowground biomass” and “root biomass” refer to the biomass of the belowground portion of a plant. In some embodiments, the methods result in a statistically significant increase in belowground biomass within the early season. In some embodiments, the methods result in a statistically significant increase in belowground biomass within 45 or 30 days after emergence. In some embodiments, belowground biomass is increased by at least 5%, 10%, 15%, 20%, 25%, 30%, 35%, 40%, 45%, 50%, 55%, 60%, or more than 60%.

As used herein, the term “total biomass” refers to the sum of the aboveground biomass and the belowground biomass of a plant. In some embodiments, the methods result in a statistically significant increase in total biomass within the early season. In some embodiments, the methods result in a statistically significant increase in total biomass within 45 or 30 days after emergence. In some embodiments, total biomass is increased by at least 5%, 10%, 15%, 20%, 25%, 30%, 35%, 40%, or more than 40%.

The methods of the present invention may be used to grow a variety of cereal plants. Suitable cereal plants include, without limitation, maize, rice, wheat, barley, sorghum, millet, oat, rye, and triticale. However, in preferred embodiments, the cereal plant is a rice plant and/or the cereal seed is a rice seed. Cultivated rice is typically from the species Oryza sativa. The methods may be used with long-grain, medium-grain, and short-grain rice cultivars. Specific cultivars that may be used with the methods provided herein include, but are not limited to, the rice cultivars ‘Diamond’, ‘Jewel’, ‘DG363L’, ‘CLL 15’, ‘CLL 16’, ‘CLL 17’, ‘PVL02’, ‘PVL03’, ‘RTV7231MA’, ‘CLJ 01’, ‘Jupiter’, ‘Titan’, ‘Lynx’, ‘RT753XP’, ‘RT7321FP’, and ‘RT7521FP’.

A seed treatment composition may be a powder, slurry, or liquid. The principal objective of a seed treatment is to coat the seed with an effective amount of a seed treatment composition. Exemplary methods for applying a seed treatment composition to a seed include dusting the seed with the composition, spraying the seed with a concentrated formulation of the composition, and soaking the seed in a solution comprising the composition.

Cereal seeds may be planted using several techniques. For example, in the United States, rice production is broadly categorized as either dry-seeded or water-seeded. In dry-seeded methods, rice is sown into a prepared seedbed with a grain drill or by broadcasting the seed and incorporating it with a disk or harrow. Moisture for seed germination is then provided by irrigation or rainfall. Thus, in some embodiments, fenclorim is applied to the rice seeds as a dusting or concentrated formulation, and the seeds are planted by a dry-seeded method. In contrast, in water-seeded methods, rice seed is soaked for 12 to 36 hours to initiate germination, and the seed is broadcast by airplane into a flooded field. The seedlings emerge through a shallow flood, or the water may be drained from the field for a short period of time to enhance seedling establishment. Thus, in embodiments, fenclorim is applied to the rice seeds by including it in a soaking solution used to initiate germination, and the seeds are planted by a water-seeded method.

The term “effective amount of fenclorim” refers to an amount of fenclorim that provides the desired effect (i.e., stimulates early season vigor or canopy formation), either following single or multiple applications. An effective amount can be determined by one skilled in the art using known techniques and by observing results obtained under analogous circumstances. In determining the effective amount of fenclorim to be applied to a seed, a number of factors can be considered, such as: the species or variety of the seed, the growing location, the time of planting, soil conditions, abiotic stresses, and the like. For seed treatment, 0.1 to 10.0 g of fenclorim may be applied per kg of seed. In Example 1, the inventors demonstrate that treating rice seeds with fenclorim at a rate of 0.625, 1.25, 2.5, or 5 g/kg seed results in increased groundcover (see Table 2). Thus, in preferred embodiments, the effective amount of fenclorim is between 0.5 and 5.0 g per kg seed.

By increasing tillering and canopy formation, the methods of the present invention may improve weed control, i.e., because canopy formation is directly linked to prevention of weed emergence. A “weed” is a plant that is considered a nuisance to or a competitor of a commercially important crop plant. As used herein, the term “weed control” refers to any observable reduction in weed growth or vigor. Weed control can include (1) killing, (2) inhibiting growth, reproduction or proliferation, or (3) removing, destroying, or otherwise diminishing weeds. Weed control can be assessed visually. For example, weed control can be assessed by comparing the number or size of weeds surrounding treated plants to that of weeds surrounding untreated plants. Weed control may be defined, for instance, in terms of the number of weed plants or weight of the weeds that grow around treated plants as a percentage of the number or weight of the weeds that grow around untreated plants.

Examples of weeds that may be controlled using the methods of the present invention include, but are not limited to, barnyardgrass (Echinochloa crus-galli) and other weed species within the Echinochloa genus, crabgrasses within the genus Digitaria, Palmer amaranth (Amaranthus palmeri) and other weed species within the Amaranthus genus, common purslane (Portulaca oleracea) and other weed species in the Portulaca genus, Chenopodium album and other Chenopodium spp., Setaria lutescens and other Setaria spp., Solanum nigrum and other Solanum spp., Lolium multiflorum and other Lolium spp., Brachiaria platyphylla and other Brachiaria spp., Conyza canadensis and other Conyza spp., and Eleusine indica. In certain preferred embodiments, the weed species is Oryza sativa L. var. sylvatica (weedy rice) or Oryza sativa L. (red rice).

### Methods of Comparing the Early Season Vigor or Canopy Formation of Cereal Plants:

In a second aspect, the present invention provides methods for comparing the early season vigor or canopy formation of a cereal plant grown from a seed that was treated with an effective amount of fenclorim to that of a control plant. The methods comprise (a) growing the cereal plant and the control plant under substantially similar conditions; (b) measuring an indicator of early season vigor or canopy formation in both the cereal plant and the control plant; and (c) comparing the measurements obtained in (b).

Suitable indicators of early season vigor or canopy formation include, without limitation, leaf area, plant density, plant height, dry matter accumulation, and various growth parameters. In Example 2, the inventors demonstrate that rice plants grown from fenclorim-treated seeds have increased leaf area, increased groundcover, increased aboveground biomass, increased belowground biomass, and increased total biomass as compared to control plants. Thus, in some embodiments, the indicator of early season vigor or canopy formation is leaf area, groundcover, aboveground biomass, belowground biomass, total biomass, or any combination thereof. In some embodiments, cereal plant grown from the fenclorim-treated seed exhibits an increase in leaf area, groundcover, aboveground biomass, belowground biomass, total biomass, or any combination thereof relative to the control plant.

Methods of Planting Cereal Seed at Lower than Recommended Seed Counts:

In a third aspect, the present invention provides agricultural methods that comprise planting cereal seed treated with an effective amount of fenclorim at a lower than recommended seed count.

The terms “seed count” and “seeding rate” refer to the number of seed per unit. Seed count is used to quantify how much seed is necessary to cover a given planting area. For example, seed count may be expressed as the number of seed per square foot, the number of seed per row foot for a given row width, or pounds of seed per acre. In Example 1, the inventors demonstrate that treating seeds with fenclorim increases the number of rice plant shoots at 60 days after emergence as compared to control plants (see Table 3). Thus, fenclorim treatment allows seeds to be planted at a lower seed count than recommended for seed lacking fenclorim treatment. In some embodiments, the fenclorim treated cereal seed may be planted at less than 24, 22, 20, 18, 16, 14, 12, 10, 8, 6, or 4 seeds by square foot. For comparison, the recommended seed count is about 30 seeds per square foot for conventional, non-hybrid rice cultivars and 11 seeds per square foot for hybrid rice cultivars (see Table 1). The present technology allows for reductions in seed count from these recommendations.

TABLE 1
Pounds seed per acre at various seed densities for selected rice cultivars

| | | Seeding rate (seed/ft²) | | | | | | | |
|---|---|---|---|---|---|---|---|---|---|
| | Seed | 10 | 12 | 14 | 25¹ | 30 | 35 | 40 | 45 |
| Cultivar | per lb | lbs/acre | | | | | | | |
| ARoma 17 | 19,463 | — | — | — | 56 | 67 | 78 | 90 | 101 |
| CL111 | 18,515 | — | — | — | 59 | 71 | 82 | 94 | 106 |
| CL151 | 19,346 | — | — | — | 56 | 68 | 79 | 90 | 101 |
| CL153 | 19,146 | — | — | — | 57 | 68 | 80 | 91 | 102 |
| CLL15 | 19,102 | — | — | — | 57 | 68 | 80 | 91 | 103 |
| CLL16 | 18,493 | — | — | — | 59 | 71 | 82 | 94 | 106 |
| CLM04 | 18,880 | — | — | — | 58 | 69 | 81 | 92 | 104 |
| DG263L | 19,410 | — | — | — | 56 | 67 | 79 | 90 | 101 |
| Diamond | 18,843 | — | — | — | 58 | 69 | 81 | 92 | 104 |
| Jazzman-2 | 20,497 | — | — | — | 53 | 64 | 74 | 85 | 96 |
| Jewel | 20,138 | — | — | — | 54 | 65 | 76 | 87 | 97 |
| Jupiter | 17,584 | — | — | — | 62 | 74 | 87 | 99 | 111 |
| LaKast | 18,283 | — | — | — | 60 | 71 | 83 | 95 | 107 |
| Lynx | 16,645 | — | — | — | 65 | 79 | 92 | 105 | 118 |
| ProGold1 | 18,614 | — | — | — | 59 | 70 | 82 | 94 | 105 |
| ProGold2 | 18,729 | — | — | — | 58 | 70 | 81 | 93 | 105 |
| PVL02 | 20,816 | — | — | — | 52 | 63 | 73 | 84 | 94 |
| Titan | 16,470 | — | — | — | 66 | 79 | 93 | 106 | 119 |
| RT 7301 | 19,899 | 22 | 26 | 31 | — | — | — | — | — |
| RT 7321 FP | 18,579 | 23 | 28 | 33 | — | — | — | — | — |
| RT 7401 | 19,443 | 22 | 27 | 31 | — | — | — | — | — |
| RT 7501 | 20,500 | 21 | 25 | 30 | — | — | — | — | — |
| RT 7521 FP | 18,498 | 24 | 28 | 33 | — | — | — | — | — |
| RT XP753 | 19,647 | 22 | 27 | 31 | — | — | — | — | — |

¹Only recommended under optimum conditions² with addition of an insecticide/fungicide seed treatment.
²Assumes good seedbed, drill-seeded, silt loam, optimum planting date, and conventional tillage.

### Additional Treatments:

In some embodiments, the cereal seed may be additionally treated with one or more agrochemicals, such as an insecticide, fungicide, or plant growth regulator. Application of the fenclorim seed treatment may occur before, at the same time, or after the application of another agrochemical.

An effective amount of fenclorim may be an amount that, when used with an effective amount of an agrochemical, allows for or improves the efficacy of the agrochemical as compared to the same amount of the agrochemical alone. In embodiments where the agrochemical is an herbicide, an effective amount of fenclorim improves the control of weeds as compared to the same amount of the agrochemical alone administered under the same conditions.

In some embodiments, an improvement in efficacy is a reduction in the effective amount of the agrochemical needed in combination with the metabolic inhibitor to achieve the desired effect as compared to the same amount of agrochemical alone. The reduction may be at least 10%, 20%, 30%, 40%, or 50% or between 10-90%, 20-90%, 30-90% 40-90% or 50-90%.

In the Examples, all seed, including seed that was not treated with fenclorim, was treated with a base treatment comprising a standard rice insecticide (i.e., NipsIt®) and fungicide (i.e., a combination of metalaxyl, fludioxonil, carboxin, and thiram). Thus, in some embodiments, the cereal seed is further treated with an insecticide and/or fungicide, or the methods further comprise treating seed of the cereal plant with an insecticide and/or fungicide. An “insecticide” is a chemical used to control insects by killing them or preventing them from engaging in undesirable or destructive behaviors. Examples of suitable insecticides for use with the present invention include, without limitation, NipsIt®, CruiserMaxx®, Dermacor®, and Fortenza®. A “fungicide” is a chemical used to kill or prevent the growth of fungi and their spores. Examples of suitable fungicides for use with the present invention include, without limitation, metalaxyl, fludioxonil, carboxin, and thiram.

Grow regulators can be used to promote vigorous root growth and early emergence. Thus, in some embodiments, the cereal seed is further treated with a growth regulator, or the methods further comprise treating seed of the cereal plant with a growth regulator. A “growth regulator” is a chemical used to modify plant growth. Growth regulators can be used, for example, to increase branching, increase shoot growth, or alter fruit maturity. Growth regulators include both synthetic and naturally occurring substances. Examples of growth regulators include auxin and gibberellin.

Fenclorim is a safener known to reduce the injury to rice caused by chloroacetanilide herbicides. Thus, treating seeds with fenclorim allows for expanded use of herbicides. “Herbicides” are substances used to control weeds. In some embodiments, the cereal seed is further treated with an herbicide, or the methods further comprise applying an herbicide to the cereal seed, cereal plant, or the surrounding plot. Suitable herbicides include preplant, preemergence, and postemergence herbicides. Exemplary herbicides that can be used in combination with fenclorim seed treatment include, without limitations, pigment inhibitors, such as an isoxazolidinone (e.g., clomazone); seedling root growth inhibitors, such as a dinitroaniline (e.g., pendimethalin); and seedling shoot growth inhibitors, such as a thiocarbamate (e.g., thiobencarb).

The present invention may also provide an agricultural method that improves the efficacy of a herbicide. By increasing tillering and canopy formation, improved weed control since canopy formation is directly linked to prevention of weed emergence. The methods may achieve a commercially acceptable rate of weed control. The commercially acceptable rate of weed control varies with the weed species, degree of infestation, environmental conditions, and the associated crop plant. Typically, commercially effective weed control is defined as the destruction or inhibition of at least about 60%, 65%, 70%, 75%, 80%, 85%, or 90% of the weed plants. Although it is generally preferable from a commercial viewpoint that at least 70-80% of the weeds are destroyed or inhibited, commercially acceptable weed control can occur at much lower levels of destruction or inhibition, particularly with very noxious, herbicide-resistant weeds. Herbicide may be applied to the cereal plant or seed at an amount that is less than recommended. The recommended amount of herbicide may be the amount of herbicide recommended for application to the cereal plant according to the herbicide's label. The reduction in applied about of herbicide may be at least 10%, 20%, 30%, 40%, or 50% or between 10-90%, 20-90%, 30-90% 40-90% or 50-90% to achieve a commercially acceptable rate of weed control.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

### Example 1

### Cultivar Screening

An experiment was conducted to screen for the effects of a fenclorim seed treatment across sixteen of the most common rice cultivars planted in the state of Arkansas. The cultivars screened in the study included ten long-grain inbreds, three medium-grain inbreds, and three long-grain hybrids: ‘Diamond’, ‘Jewel’, ‘DG363L’, ‘CLL 15’, ‘CLL 16’, ‘CLL 17’, ‘PVL02’, ‘PVL03’, ‘RTV7231MA’, ‘CLJ 01’, ‘Jupiter’, ‘Titan’, ‘Lynx’, ‘RT753XP’, ‘RT7321FP’, and ‘RT7521FP’. All seeds were treated with a base treatment comprising a standard rice insecticide (i.e., NipsIt®) and fungicide (i.e., a combination of metalaxyl, fludioxonil, carboxin, and thiram) using a commercial seed treater. Additionally, each seed was treated with 0 or 2.5 g fenclorim per kg of seed. Seed was planted on Apr. 19, 2021, utilizing nine-row plots (5.2 m by 3 m). Aerial images were captured using a DJI Mavic Air 2 45 days after emergence, and images were analyzed using Turf Analyzer. Images taken at 45 days after emergence suggest that the fenclorim seed treatment caused a 7% increase in groundcover averaged across all cultivars.

### Diamond Rice Evaluation

An experiment was conducted to test whether fenclorim seed treatment would influence rice growth in a heavy clay soil. Diamond rice was planted on Apr. 22, 2021, using the same practices as the previous experiment, including a treatment with 0 or 2.5 g fenclorim per kg of seed. Drone images captured 45 days after emergence suggest that fenclorim caused a 4% increase in groundcover in heavy clay soil.

### Fenclorim Dose-Response Study

On Apr. 17, 2021, an experiment was initiated to identify the best rate at which to apply fenclorim as a rice seed treatment. The experiment was conducted using four rice cultivars (Diamond, Titan, RT7521FP, and RT7321FP) and 5 rates of the fenclorim (0, 0.625, 1.25, 2.5, and 5 g/kg seed). Seeds were treated using the aforementioned methods with all seeds having the same base seed treatment. Drone images were taken 45 days after emergence and showed increased groundcover with various rates of fenclorim (Table 2). At 2.5 g fenclorim per kg of seed, there was a 22% increase (averaged across cultivars) in groundcover compared to the no fenclorim treatment at 45 days after emergence. In this study, rice plant heights and shoot numbers were measured 30 days after emergence. The heights of five random plants were measured per plot and shoot numbers were measured in two 0.5 m sections of row. While heights were not influenced by the fenclorim seed treatment, an increase in shoot number was observed as the seed treatment rate increased (Table 3).

TABLE 2
Groundcover of four rice cultivars grown from seed treated with various
rates of fenclorim. The percent increase in groundcover as compared
to control plants was averaged over all four cultivars.

| | Fenclorim seed treatment | | | | Increase |
|---|---|---|---|---|---|
| | Diamond | Titan | RT7521FP | RT7321FP | over |
| g/kg seed | Groundcover (%) | | | | control % |
| 0 | 42.1 | 44.3 | 48.1 | 35.1 | |
| 0.625 | 47.3 | 49.3 | 51.8 | 41.2 | 12 |
| 1.25 | 54.6 | 47.3 | 52.5 | 46.0 | 18 |
| 2.5 | 54.2 | 48.1 | 51.2 | 53.9 | 22 |
| 5.0 | 52.2 | 50.6 | 55.9 | 50.3 | 23 |

TABLE 3
Shoot numbers of four rice cultivars grown from seed treated
with various rates of fenclorim, provided as a percentage
of shoot numbers produced by control plants.

Fenclorim seed treatment

| | | | |
|---|---|---|---|
| Diamond | Titan | RT7521FP | RT7321FP |

| | |
|---|---|
| g/kg seed | Shoots (%) |

| | | | | |
|---|---|---|---|---|
| 0 | 100 | 100 | 100 | 100 |
| 0.625 | 98.6 | 111.1 | 110.7 | 115.2 |
| 1.25 | 111.1 | 110.5 | 112.4 | 110.3 |
| 2.5 | 106.9 | 105.3 | 108.8 | 108.4 |
| 5.0 | 100 | 102.4 | 111.9 | 112.3 |

### Example 2

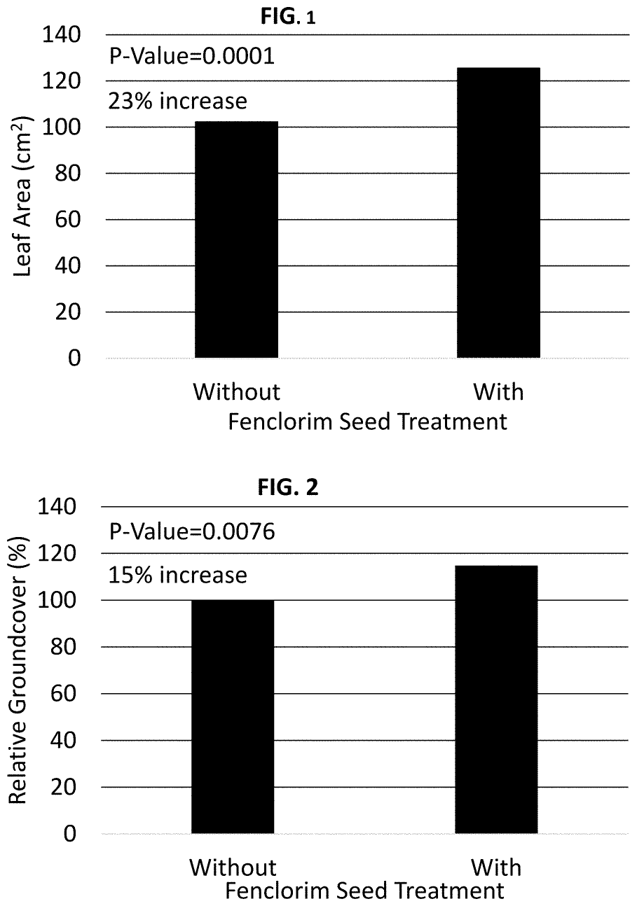

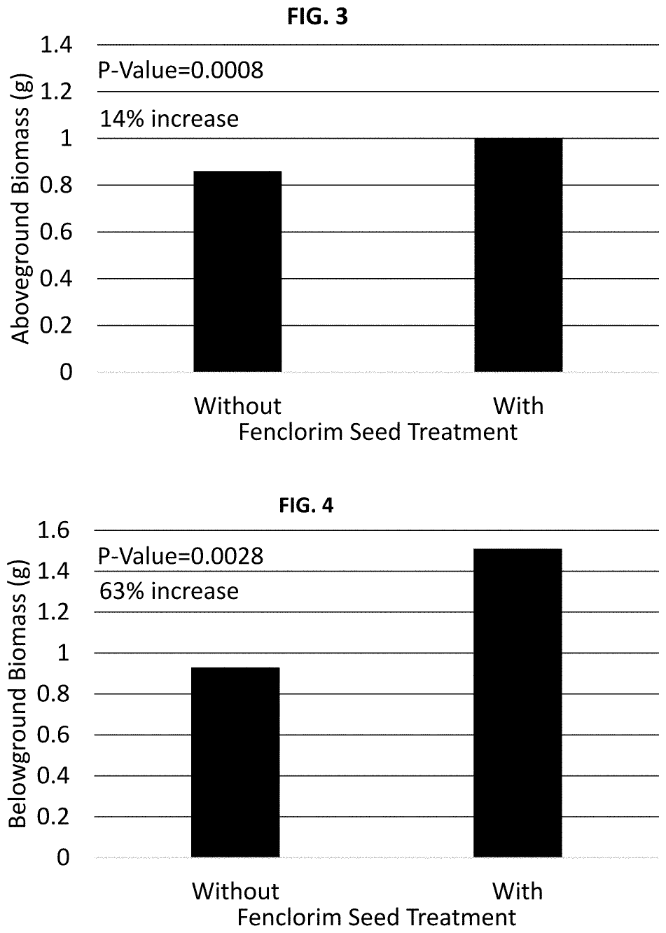

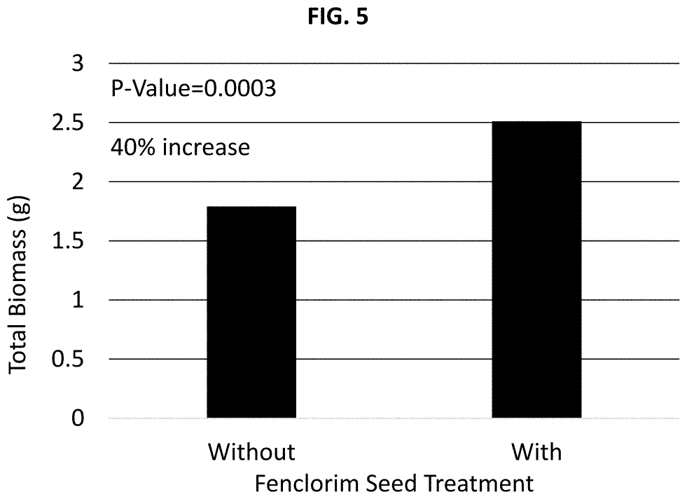

A greenhouse biostimulant experiment was performed in 2 experimental runs. Fenclorim was applied to rice seed at 0 or 2.5 g/kg of seed. Five rice seeds of the cultivar Diamond were planted in silt loam soil in 4″ diameter pots 0.5″ apart. At least 9 replications were performed per run. At 14 days after emergence, emerged rice was counted and thinned to 3 plants per pot. Data were collected 30 days after emergence. The leaf area of the rice plants in each pot was determined. Groundcover was determined based on the number of green leaf pixels from an overhead image. Shoot (aboveground) and root (belowground) biomass were determined, and total biomass was determined by adding the mass of the roots and shoots. These results show that the fenclorim seed treatment resulted in a 23% increase in leaf area (FIG. 1), a 15% increase in groundcover (FIG. 2), a 14% increase in aboveground biomass (FIG. 3), a 63% increase in belowground biomass (FIG. 4), and a 40% increase in total biomass (FIG. 5).

1. A method comprising stimulating early season vigor or canopy formation in a cereal plant, wherein early season vigor or canopy formation is stimulated by planting seed of the cereal plant treated with an effective amount of fenclorim.

2. The method of claim 1, wherein the method increases the leaf area, groundcover, aboveground biomass, belowground biomass, or any combination thereof of the cereal plant relative to a control plant.

3. The method of claim 2, wherein the method increases the leaf area by a statistically significant amount relative to the control plant by 30 days after emergence.

4. The method of claim 2, wherein the method increases the groundcover by a statistically significant amount relative to the control plant by 30 days after emergence.

5. The method of claim 2, wherein the method increases aboveground biomass by a statistically significant amount relative to the control plant by 30 days after emergence.

6. The method of claim 2, wherein the method increases belowground biomass by a statistically significant amount relative to the control plant by 30 days after emergence.

7. The method of claim 1, wherein the cereal plant is a rice plant.

8. The method of claim 1, wherein the effective amount of fenclorim is between 0.5 and 5.0 g/kg seed.

9. The method of claim 1 further comprising treating seed of the cereal plant with an insecticide, fungicide, herbicide, growth regulator, or any combination thereof.

10. The method of claim 9, wherein the herbicide is clomazone, pendimethalin, or thiobencarb.

11. The method of claim 1 further comprising applying a herbicide at a lower than recommended amount.

12. A method for comparing the early season vigor or canopy formation of a cereal plant grown from a seed that was treated with an effective amount of fenclorim to that of a control plant, the method comprising:
a) growing the cereal plant and the control plant under substantially similar conditions;
b) measuring an indicator of early season vigor or canopy formation in both the cereal plant and the control plant; and
c) comparing the measurements obtained in (b).

13. The method of claim 12, wherein the indicator of early season vigor or canopy formation is leaf area, groundcover, aboveground biomass, belowground biomass, or any combination thereof.

14. The method of claim 13, wherein the cereal plant exhibits an increase in leaf area, groundcover, aboveground biomass, belowground biomass, or any combination thereof relative to the control plant.

15. The method of claim 12, wherein the cereal plant is a rice plant.

16. The method of claim 12, wherein the effective amount of fenclorim is between 0.5 and 5.0 g/kg seed.

17. A method comprising planting cereal seed treated with an effective amount of fenclorim at a lower than recommended seed count.

18. The method of claim 17, wherein the recommended seed count is less than or equal to 24 seeds per square foot.

19. The method of claim 18, wherein the recommended seed count is less than or equal to 8 seeds per square foot.

20. The method of claim 17, wherein the cereal seed is rice seed.

21. The method of claim 17, wherein the effective amount of fenclorim is between 0.5 and 5.0 g/kg seed.

22. The method of claim 17, wherein the cereal seed is further treated with an insecticide, fungicide, herbicide, growth regulator, or any combination thereof.

23. The method of claim 22, wherein the herbicide is clomazone, pendimethalin, or thiobencarb.

24. The method of claim 17 further comprising applying a herbicide at a lower than recommended amount.
